(19) United States
(12) Patent Application Publication
(10) Pub. No.: US 2007/0161744 A1
(43) Pub. Date: Jul. 12, 2007

(54) (Meth) acrylate sirup as a suspension stabilisator for colourants

(75) Inventors: Klaus Kabs, Pfungstadt (DE); Frank Schafer, Gross-Gerau (DE); Hans Lichtenstein, Reinheim (DE); Bernd Klossek, Darmstadt (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO., KG, Darmstadt (DE)

(21) Appl. No.: 10/589,270

(22) PCT Filed: Jan. 14, 2005
(86) PCT No.: PCT/EP05/00310

§ 371 Date: Aug. 14, 2006

(30) Foreign Application Priority Data
Mar. 17, 2004 (DE) 10 2004 015 355.8

(51) Int. Cl. C08L 31/00

(52) U.S. Cl. 524/556; 526/319; 526/317.1; 526/310; 526/279

(57) ABSTRACT

The invention relates to a polymer solvent binding agent for pigments based on methylmethacrylate. The binding agent is a polymer made of methylmethacrylate and one or several additional radical polymerisierable compounds and is used in the form of a partially polymerised sirup.

### FIELD OF THE INVENTION

The invention relates to functional (meth)acrylate syrups or monomer-polymer systems as binders and as suspension stabilizers for colorants and colorant concentrates. Functional syrups hereinafter mean partially polymerized mixtures composed of methyl methacrylate (MMA) and of functionalized methacrylates. The partial polymerization reaction is continued to a point at which the resultant monomer-polymer mixture can still be pumped. For the coloring of plastics, there are industrial colorants available which permit almost any desired coloring of the plastics molding. Plastics are colored mainly either via bulk coloring during the production of the plastics or during the processing of plastics powders or of plastics pellets. The coloring process is matched to the respective plastic. When the colorants are incorporated into the plastics monomers or into the prepolymers, it is advantageous to use certain colorant concentrates, which are composed of the colorants or pigments together with binders. These mixtures are termed masterbatches. Similar techniques are also used in the coloring of plastics powders or of plastics pellets. The main difficulty consists in achieving uniform dispersion of the pigments in the pigmenting concentrate, and this in turn is a precondition for uniform pigment dispersion in the plastics molding. Pigment agglomeration in plastics moldings generally impairs their mechanical and optical properties.

EP 0 130 576 (Röhm GmbH) describes a solid polymeric binder and the colorant concentrates produced therefrom.

### OBJECTS

The means of coloring of acrylic sheet using prior-art bulk coloring have failed to meet some requirements. These requirements are oriented not only toward the immediate ease of incorporation of the color concentrates but also toward the effects on the acrylic sheet colored therewith:
The color concentrates are intended to have good solubility in the monomer or in prepolymers. They are moreover intended not to impair the course of polymerization and the demolding of the products from the glass plates of the mold. The pigments are intended to have good dispersion in the polymerization mixtures, and a particular requirement is that the disperse condition of the pigments has to have sufficient stability, meaning that there must be no sedimentation or reagglomeration of the pigments. It is desirable that the dispersions produced using the color concentrates remain stable over a period of from hours to days, in order to have the desired flexibility in the manufacturing process.
The intention is that the colorants or pigments be capable of good mechanical processing to give a colorant concentrate.
The intention is that there be no adverse effect on the processes to which the acrylic sheet is subjected after conclusion of the polymerization reaction, for example heat-conditioning, forming, stretching, etc.
The intention is that the other mechanical properties of the colored acrylic sheet, the Vicat softening point, and the weathering performance, be no poorer than for normal acrylic sheet.

### ACHIEVEMENT OF OBJECT

It has now been found that the partially polymerized syrup has very good suitability for pigment stabilization as claimed in the claims, for achievement of the object described. The partially polymerized syrup comprises a polymer composed of the following components:
A) proportions of from 90-99.9% by weight (based on the total weight of the polymer) of methyl methacrylate
B) from 0.1-10% by weight (based on the entire polymer P) of one or more monomers of the formula I capable of free-radical polymerization 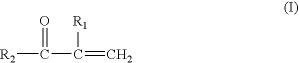
   where R₁ is hydrogen or methyl
   and R₂ is a moiety having a functional group and selected from one of the following types a) to g)
   a) a hydroxy group
   b) an 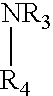
   group, where R₃ and R₄, independently of one another, are hydrogen or an unbranched or, if appropriate, branched alkyl moiety having from 1-6 carbon atoms, or where R₃ together with R₄, with involvement of the nitrogen and, if appropriate, together with further nitrogen or oxygen atoms, form a five- or six-membered heterocyclic system,
   c) an R′₃R′₄N—X—Y— group, where X is a linear or, if appropriate, branched, if appropriate cyclic alkylene group having from 2 to a total of 10 carbon atoms, Y is oxygen or an —NR₅— moiety, and R′₃ and R′₄ are defined as for R₃ and R₄, and R₅ is hydrogen or an alkyl moiety having from 1 to 6 carbon atoms, or
   d) an HO—X′-Y′ group, where X′ and Y′ are defined as for X and Y,
   e) an 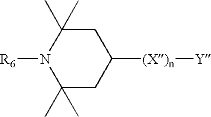
   group,
      where X″ and Y″ are defined as for X and Y, n is zero or one, and R₆ is hydrogen or an alkyl moiety having from 1 to 6 carbon atoms,
   f) an (R₇O)₃—Si—X′″—Y′″ group, where R₇ is an alkyl moiety having from 1 to 6 carbon atoms, and X′″ and Y′″ are defined as for X and Y
   g) an 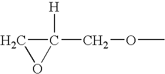
   group.

The inventive syrup can be very effectively processed and dispersed together with any of the pigments known per se.

Use of the Syrup as Additive for Colorant Concentrates

The colorants suitable for production of the colorants used are those also suitable for the coloring of the polymers, i.e. either inorganic or organic dyes or pigments or nanoparticles. They can be found in the prior art, based on the plastics to be colored (cf. Vieweg-Esser, Kunststoff-Handbuch [Plastics Handbook], volume IX, ‘Polymethacrylate’ [Polymethacrylates], C. Hanser Verlag 1975).

Examples of particularly suitable pigments are pigments similar to quinacridone and dioxazine, phthalocyanine green, phthalocyanine blue, titanium dioxide, iron oxide, and grades of carbon black.

The concentration of the colorants in the inventive syrup is generally from 10-70% by weight, preferably from 30-60% by weight, and particularly preferably from 40-50% by weight, based on the weight of the syrup.

The colorants are incorporated into the inventive syrup by means of the conventional processes known in the prior art.

The proportion of the masterbatch in the entire mixture (the entire mixture being generally composed of monomers, of prepolymer, of the inventive syrup, of initiator, of regulators, and of other auxiliaries) is generally from 0.05-10% by weight, preferably from 0.1-5% by weight, and particularly preferably from 0.5-3% by weight. The usual method, for example incorporation by stirring, can be used for introduction into the precursors used for the polymerization of the acrylic or methacrylic resins as in the prior art, examples being syrups, prepolymers, and/or monomers and monomer mixtures. The subsequent steps of processing, for example the charging of the syrup to the polymerization cells used for shaping, and the subsequent polymerization step, can then be based on the prior-art process, as also can the subsequent demolding of the finished polymer sheets.

Acrylic resins (matrix polymers) are generally entirely or substantially composed of esters of acrylic and of methacrylic acid, in particular methyl methacrylate (MMA) as monomers, and if appropriate also of other copolymerizable monomers alongside MMA.

The matrix polymers based on methyl methacrylate can by way of example also comprise proportions of from 0 to about 45% by weight of other comonomers.

Mention may be made of other esters of methacrylic acid and, respectively, acrylic acid, e.g. methyl acrylate, butyl acrylate, methyl α-chloroacrylate, ethyl methacrylate; and also (if appropriate substituted) amides of acrylic and, respectively, methacrylic acid, e.g. acrylamide and methacrylamide, methylolmethacrylamide, and methylolacrylamide. Acrylonitrile, styrene and derivatives of the same, such as α-methylstyrene, vinyl esters of carboxylic acids, e.g. vinyl acetate, and the like may also be mentioned.

Particular mention may be made of the presence of crosslinking monomers, e.g. ethylene glycol dimethacrylate, 1,4-butanediol dimethacrylate, triglycol dimethacrylate, trimethylolpropane trimethacrylate, or allyl compounds, e.g. allyl methacrylate, triallyl cyanurate, or triallyl isocyanurate. Impact modifiers can also be used.

The polymerization reaction can be carried out in a manner known per se, using known industrial methods (cf. H. Rauch-Puntigam and Th. Völker in “Acryl-und Methacrylverbindungen” [Acrylic and Methacrylic Compounds], Springer-Verlag 1967 and J. Brandrup—E. H. Immergut, Polymer Handbook, 2nd Edition, Wiley-Interscience (1975). Outlines of appropriate techniques have been previously described in DE-C 639 095.

Preparation of the Polymers

Examples of initiators that can be used for the free-radical polymerization of the monomers (for example of the acrylic monomers, styrene and derivatives, esters of vinyl compounds) are the conventional amounts of peroxide compounds or of azo compounds. The known regulators and/or retarders at the concentrations known per se are suitable for control of molecular weight. Examples which may be mentioned are organosulfur compounds or terpenes.

As is known, the degree of polymerization and therefore the molecular weight of the resultant resin molecules can be adjusted via the initiator concentration or/and regulator concentration. For example, from 0.01 to 1.0% by weight of initiator will usually be used in polymerization of acrylic resins. The amount added of regulator and/or retarder is generally from 0.01 to 0.5% by weight, preferably from 0.05 to 0.2% by weight. The molecular weights (M_{w}) of the matrix polymers are generally in the range from 2-10⁵ to 5-10⁶. In the majority of cases, the matrix polymer has weak crosslinking. The Vicat softening point (to DIN 53 460, method B) is generally >100° C. The polymerization mixtures can moreover comprise the auxiliaries known per se, e.g. UV absorbers, plasticizers, light stabilizers, heat stabilizers, antioxidants, flame retardants, etc.

Preparation of the Functional Pigment-Stabilizing Syrup

The syrup can likewise be prepared by a method closely based on the polymerization processes of the prior art (see above “preparation of the polymers”).

The polymerization reaction is generally initiated via free-radical generators, preferably via the conventional amounts of peroxide compounds or of azo compounds (mostly from 0.02 to 0.1% by weight, based on the monomers). It is also advantageously possible to use the known redox systems, accelerators, etc. (cf. H. Rauch-Puntigam “Acryl-und Methacrylverbindungen” [Acrylic and Methacrylic Compounds], Springer-Verlag 1967). Here again, the known regulators and/or retarders are suitable for control of molecular weight, examples being the concentrations known per se of sulfur regulators. The amount added of regulator is generally from 0.01 to 0.5% by weight, preferably from 0.05 to 0.2% by weight.

By way of example, the syrup is prepared as specified below:

For each mixture, about 750 kg of MMA plus additives are needed. The mixture comprises MMA, 5% of 2-hydroxyethyl methacrylate, 1% of 2-dimethylaminoethyl methacrylate, and 0.04% of 2,2′-azobis(2,4-dimethylvaleronitrile) initiator. After thorough mixing, half of the solution is used as an initial charge in the reaction vessel. The other half remains in the feed vessel. The reaction procedure is initiated automatically. In this case, the solution is heated to 73° C. At this temperature, the feed of the other half of the solution from the feed container at from 18 l/min to 30 l/min begins automatically. The temperature is intended not to exceed 93° C. Once the feed has ended, mixture is discharged into the cooling vessel. The proportion of polymer is from 10-30%, as a function of cooling conditions. Viscosity measured in a 6 mm Ford cup is from 30-60 sec (to DIN 53211).

Production of a Colored Acrylic Sheet

Here again, the procedure can be based on the procedures of the prior art. An example of an advantageous method starts from a methacrylate prepolymer with which the conventional polymerization aids and colorants have been admixed. The inventively obtained syrup preparation (from 1-3%, based on the mixture), is then introduced into the mixture and intensive mixing is provided, e.g. with the aid of a stirrer assembly, and then the mixture is preferably allowed to stand for some time and is then charged to the polymerization cell. The usual method of polymerization is used, mostly followed by final polymerization at an elevated temperature; for example in a heat-conditioning cabinet at about 120° C. The product after demolding is colored acrylic sheet with ideal pigment dispersion, and this sheet has entirely satisfactory surfaces after heating to forming temperature and even after stretching.

Variations in the Use of the Functionalized Methcacrylate Syrup

Variant 1 in the Use of the Functional Syrup

Variant 1 of the process consists in mixing color paste and the functional syrup in a ratio of 4:1 and then adding this mixture to the polymerization tank in which the other components are present.

The second variant of the process consists in using the color as initial charge in the form of a masterbatch together with the functional, inventive syrup in the tank, and adding some or all of the rest of the polymerization mixture and charging this material to the polymerization cells.

Advantageous Effects of the Inventive Syrup

The inventive syrup substantially meets the industrial requirements described at the outset.

The colorant concentrates have good solubility in the monomers or prepolymers. Their addition does not impair the course of the polymerization reaction. They provide advantages over the prior art, in particular considerable advantages during demolding. For example, it is possible to reduce the extent of, or entirely eliminate, the highly undesirable phenomenon of sheet fracture during demolding. Another favorable factor is that the disperse state is relatively stable.

Good results can be obtained in the processes which follow the polymerization procedure, e.g. heat-conditioning, forming, stretching, etc.

When comparison is made with normal acrylic sheet, there is no impairment of the mechanical and optical properties of the colored acrylic sheet, of the Vicat softening point, or of weathering performance.

What is claimed is:

1. A functional syrup based on methyl methacrylate, characterized in that
the binders are a partial polymer composed of the following components:
A) proportions of from 90-99.9% by weight (based on the entire polymer P) of methyl methacrylate
B) from 0.1 to 10% by weight (based on the entire polymer P) of one or more monomers of the formula I capable of free-radical polymerization 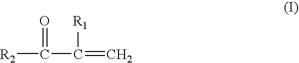
where R₁ is hydrogen or methyl and R₂ is a moiety having a functional group and selected from one of the following types a) to g)
a) the OH group
b) an 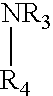
group, where R₃ and R₄, independently of one another, are hydrogen or an unbranched or, if appropriate, branched alkyl moiety having from 1 to 6 carbon atoms, or where R₃ together with R₄, with involvement of the nitrogen and, if appropriate, together with further nitrogen or oxygen atoms, form a five- or six-membered heterocyclic system
c) an R′₃R′₄N—X—Y— group, where X is a linear or, if appropriate, branched, if appropriate cyclic alkylene group having from 2 to a total of 10 carbon atoms, Y is oxygen or an —NR₅— moiety, and R′₃ and R′₄ are defined as for R₃ and R₄, and R₅ is hydrogen or an alkyl moiety having from 1 to 6 carbon atoms, or
d) an HO—X′—Y′ group, where X′ and Y′ are defined as for X and Y
e) an 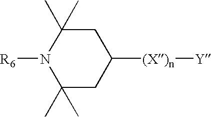
group,
where X″ and Y″ are defined as for X and Y, n is zero or one, and R₆ is hydrogen or an alkyl moiety having from 1 to 6 carbon atoms
f) an (R₇O)₃—Si—X′″—Y′″ group, where R₇ is an alkyl moiety having from 1 to 6 carbon atoms, and X′″ and Y′″ are defined as for X and Y
g) an 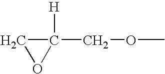
group,
and in that the monomers are polymerized to an extent of 20%.

2. The functional syrup as claimed in claim 1, characterized in that
the viscosity of the syrup is from 10-80 (6 mm Ford cup).

3. A colorant concentrate for the coloring of plastics comprising a colorant dispersed in a polymeric syrup,
characterized in that
the polymeric binder is a partial polymer composed of the following components:
A) proportions of from 90-99.9% by weight (based on the entire polymer P) of methyl methacrylate
B) from 0.1 to 10% by weight (based on the entire polymer P) of one or more monomers of the formula I capable of free-radical polymerization 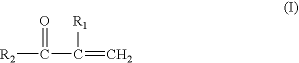
where R₁ is hydrogen or methyl and R₂ is a moiety having a functional group and selected from one of the following types a) to g)
a) the OH group
b) an 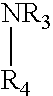
group, where R₃ and R₄, independently of one another, are hydrogen or an unbranched or, if appropriate, branched alkyl moiety having from 1 to 6 carbon atoms, or where R₃ together with R₄, with involvement of the nitrogen and, if appropriate, together with further nitrogen or oxygen atoms, form a five- or six-membered heterocyclic system
c) an R′₃R′₄N—X—Y— group, where X is a linear or, if appropriate, branched, if appropriate cyclic alkylene group having from 2 to a total of 10 carbon atoms, Y is oxygen or an —NR₅— moiety, and R₁₃ and R₁₄ are defined as for R₃ and R₄, and R₅ is hydrogen or an alkyl moiety having from 1-6 carbon atoms, or
d) an HO—X′—Y′ group, where X′ and Y′ are defined as for X and Y
e) an 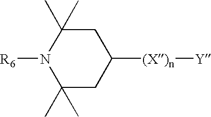
-group,
where X″ and Y″ are defined as for X and Y, n is zero or one, and R₆ is hydrogen or an alkyl moiety having from 1 to 6 carbon atoms
f) an (R₇O)₃—Si—X′″—Y′″ group, where R₇ is an alkyl moiety having from 1 to 6 carbon atoms, and X′″ and Y′″ are defined as for X and Y
g) an 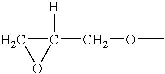
group,
and in that the polymer is polymerized to 20% conversion.

4. A plastics molding, produced using the functional syrup as claimed in claim 1.
